(19) United States
(12) Patent Application Publication
(10) Pub. No.: US 2024/0179809 A1
(43) Pub. Date: May 30, 2024

(54) INDUCTION COILS FOR COOKING SURFACES

(71) Applicant: W.C. BRADLEY CO., Columbus, GA (US)

(72) Inventors: JAMES D. KRING, Opelika, AL (US); RAMIN KHOSRAVI RAHMANI, Columbus, GA (US); Thomas Kessler, Columbus, GA (US); Jonathan Whitten, Fortson, GA (US); Bryan Solomon, Columbus, GA (US)

(21) Appl. No.: 18/525,114

(22) Filed: Nov. 30, 2023

Related U.S. Application Data
(60) Provisional application No. 63/428,885, filed on Nov. 30, 2022.

(51) Int. Cl. H05B 6/12; H05B 6/06

(52) U.S. Cl. CPC H05B 6/1272; H05B 6/065

(57) ABSTRACT

A coil system for inductive heating of a cooking surface including at least one coil having a continuous winding from a center region to an outer region. A spacing within adjacent wires in the winding varies between a center of the winding and an outer portion of the winding.

### CROSS-REFERENCE TO RELATED CASES

This application claims the benefit of U.S. provisional patent application Ser. No. 63/428,885, filed on Nov. 30, 2022, and incorporates such provisional application by reference into this disclosure as if fully set out at this point.

### FIELD OF THE INVENTION

This disclosure relates to induction heating technology in general and, more specifically, to an induction coil system for rectangular or other non-circular cooking surfaces.

### BACKGROUND OF THE INVENTION

Current induction-based, consumer-level cooking appliances use circularly-wound induction coils commonly known as pancake coils. The size and design of these coils is intended to match the circular bottoms of most pots and pans. The number of coils on the appliances typically equals the number of cooking zones on that appliance with each coil being independently controllable. Because these pancake coils are designed to heat circular-bottom pots and pans, they are incapable of uniformly and efficiently heating rectangular cooking surfaces such as cast iron griddles or other induction capable non-circular cooking surfaces. In addition, the highly concentrated level of energy transmitted from induction coils creates a very high energy flux at the coil position, but this sharply drops to near zero adjacent to the coil.

What is needed is a system and method for addressing the above, and related, issues.

### SUMMARY OF THE INVENTION

The invention of the present disclosure, in one aspect thereof, comprises a coil system for inductive heating of a cooking surface including at least one coil having a continuous winding from a center region to an outer region. A spacing within adjacent wires in the winding varies between a center of the winding and an outer portion of the winding.

In some embodiments, the spacing is larger at center region than the outer portion. The at least one coil may be rectangular. The at least one coil may be circular. It may comprise a plurality of coils. The plurality of coils may each be about the same size. At least two of the plurality of coils may differ in size.

The plurality of coils may comprise a first inner coil and a group of outer coils. The first inner coil may be larger than any coil in the group of outer coils.

Each coil in the plurality of coils may have a separate tank circuit. Each coil in the plurality of coils may be switched by a plurality of separate switches to a power supply. In other embodiments, each coil in the plurality of coils is switched by a single switch to a power supply.

In some embodiments, the at least one coil further comprises stretches of rectangular winding having spacings therebetween governed by the equation:

$$\vert {x}_{coil} \vert = ( {x}_{max} - {x}_{min} ) \times {( \frac{winding number}{total number of windings} )}^{a} + {x}_{min}$$

$$\vert {y}_{coil} \vert = ( {y}_{max} - {y}_{min} ) \times {( \frac{winding number}{total number of windings} )}^{a} + {y}_{min}$$

where xcoil and ycoil are coordinate values for a given stretch of rectangular windings as defined by the wind number, which is the quantized parameter going from zero to a maximum value of total number of windings and the maximum and minimum values for the coil winding (xmax,ymax and xmin,ymin respectively) are predetermined.

In some embodiments, the at least one coil comprises a plurality of winding lengths having spacings therebetween governed by the equation:

$${r}_{coil} = ( {r}_{max} - {r}_{min} ) \times {( \frac{winding number}{total number of windings} )}^{a} + {r}_{min}$$

where rcoil is the radius of the coil at a given point as defined by the wind number, which is the continuous parameter going from zero to a maximum value of total number of winding lengths from a center of the coil, and the maximum and minimum values for the coil winding (rmax and rmin respectively) are predetermined.

The invention of the present disclosure, in another aspect thereof, comprises an inductive cooking device having a cooking surface, and at least one induction coil below the cooking surface. The at least one induction coil comprises a winding comprising adjacent lengths of winding. The adjacent lengths of winding have a spacing that varies between a center of the coil and an edge of the coil.

In some embodiments, a spacing between adjacent lengths increases from the edge to the center of the coil. The at least one induction coil may have a non-circular arrangement to induce heat in a non-circular area on the cooking surface. In some embodiments, the at least one induction coil comprises a plurality of adjacent circular coils arranged below the cooking surface to induce heat in non-circular area on the cooking surface.

The invention of the present disclosure, in another aspect thereof, comprises an inductive cooking device including a power supply, a power switch, a rectilinear cooking surface, and an induction coil below the cooking surface arranged in a tank circuit to be energized by the power supply via the power switch. The induction coil comprises a plurality of winding lengths having a spacing between adjacent ones of the plurality of winding lengths that decreases from a center of the coil toward a perimeter of the coil.

In some embodiments, the induction coil is rectangular. In some embodiments, the induction coil comprises a plurality of circular coils each with a plurality of winding lengths having a spacing between adjacent ones of the plurality of winding lengths that decreases from a center of the coil toward a perimeter of the coil.

### BRIEF DESCRIPTION OF THE DRAWINGS

FIG. 1A is an overhead view of an induction coil system according to aspects of the present disclosure.

FIG. 1B is an overhead view of the coil system of FIG. 1A with a griddle in cutaway.

FIG. 2 is a perspective view of the system as shown in FIG. 1B.

FIG. 3A is an overhead view of another induction coil system according to aspects of the present disclosure.

FIG. 3B is an overhead view of the coil system of FIG. 3A with a griddle in cutaway.

FIG. 4 is a perspective view of the system as shown in FIG. 3B.

FIG. 5A is an overhead view of another induction coil system according to aspects of the present disclosure.

FIG. 5B is an overhead view of the coil system of FIG. 5A with a griddle in cutaway.

FIG. 6 is a perspective view of the system as shown in FIG. 5B.

FIG. 7 is a simplified schematic diagram of a control circuit for an induction coil according to aspects of the present disclosure.

FIG. 8 is another simplified schematic diagram of another control circuit for an induction coil according to aspects of the present disclosure.

FIG. 9 is another simplified schematic diagram of another control circuit for an induction coil according to aspects of the present disclosure.

FIG. 10 is another simplified schematic diagram of a control circuit for an induction coil according to aspects of the present disclosure.

FIG. 11 is another a simplified schematic diagram of a control circuit for an induction coil according to aspects of the present disclosure.

FIG. 12 is a front perspective view of one embodiment of a griddle according to aspects of the present disclosure.

### DETAILED DESCRIPTION OF THE PREFERRED EMBODIMENTS

The present disclosure describes systems and methods providing for the uniform and efficient heating of induction capable rectangular cooking surfaces, particularly those for use in outdoor environments. In other embodiments, the induction capable cooking surface is square, or has another non-circular shape (e.g., in plan view). The system comprises one or more of a plurality of induction coil designs, which may be arranged for use with a non-circular cooking surface. Methods of control of systems of the present disclosure are also provided.

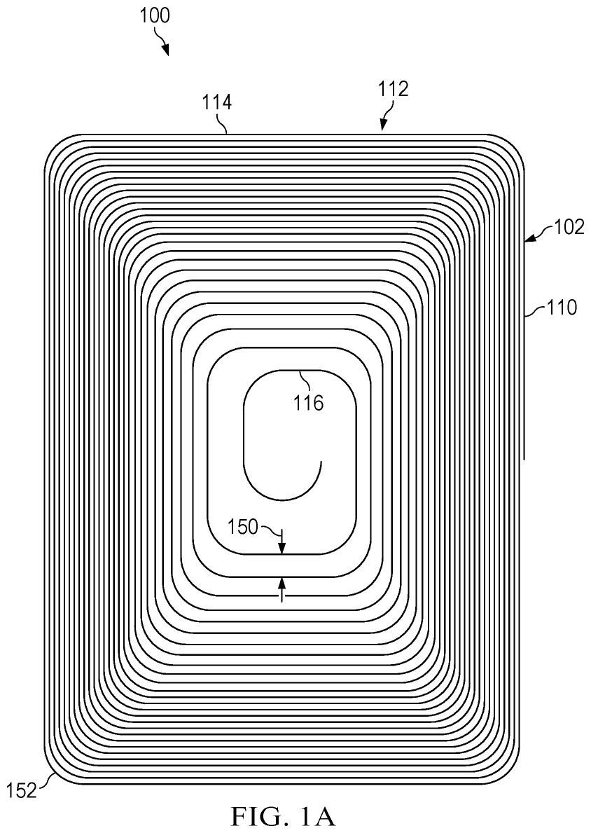

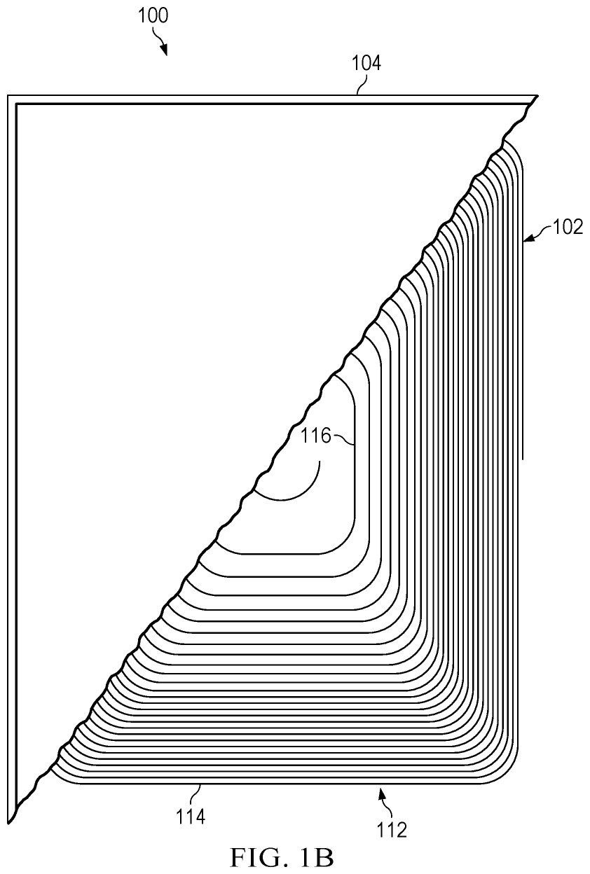

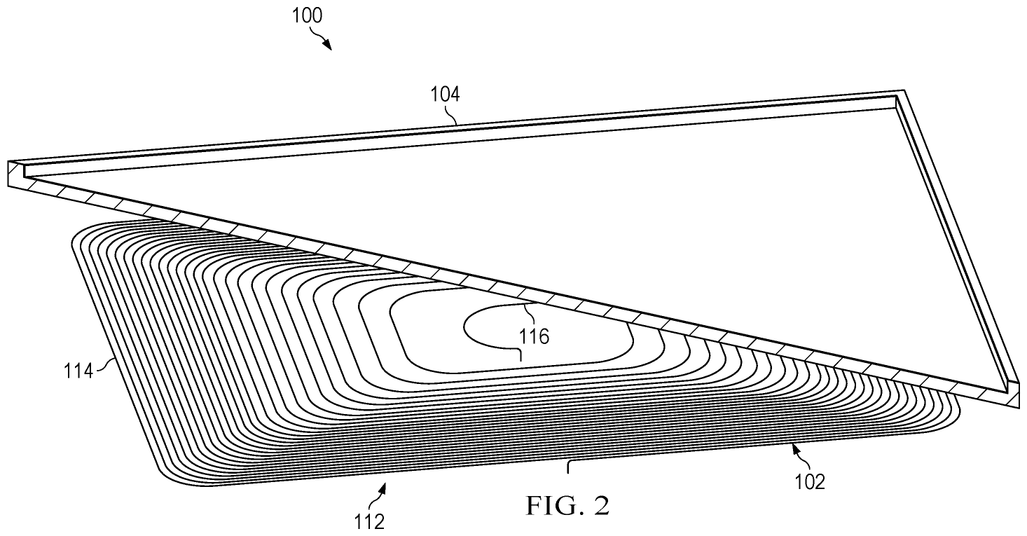

Referring now to FIG. 1A an overhead view of an induction coil 102 as part of a cooking system 100 according to the present disclosure is shown. FIG. 1B illustrates an overhead view of the system 100 with a rectangular cooking surface 104 shown in partial cutaway. FIG. 2 illustrates the system 100 in perspective view. In each of these views, and in other drawings forming part of the present disclosure, components that are known to the art such as power supplies, switches, electrical leads, cooking chambers, lids, stands, fireboxes, and other components are not shown for simplicity and clarity. One of skill in the art will readily appreciate how to incorporate the induction coils and cooking surfaces into complete devices and appliances without undue experimentation.

FIG. 1A illustrates a single induction coil 102 with rectangularly wound magnet wire intended for rectangular cooking surfaces. FIG. 1B shows a cooking surface 104 in partial cutaway. FIG. 2 illustrates the contents and arrangement of the system 100 of FIG. 1, but in perspective view. In physical embodiments, the cooking surface 104 may cover the coil 102 (at least from the overhead views of FIGS. 1-2).

The coil 102 may comprise a non-uniformly rectangularly wound magnet wire 110 (or wires when using Litz wire) coil. The wire 110 may be arranged in a plurality of nested windings 112. The number of windings 112 can vary and, for illustrative purposes, may be considered as ranging from an outer winding 114 to an inner winding 116.

Each winding 112 may have a predetermined space between it and an adjacent winding(s). Inner-most windings in the coil 102 (e.g., those nearer inner winding 116) may be spaced wider than the outermost or edge windings (e.g., those nearer outer winding 114) to generate the most uniform magnetic field possible. For illustrative purposes, an inner-most winding space is shown at 150, while an outer most winding space is shown at 152. The spacing of the windings may be based on the following parameterized relations:

$$\vert {x}_{coil} \vert = ( {x}_{max} - {x}_{min} ) \times {( \frac{winding number}{total number of windings} )}^{a} + {x}_{min}$$

$$\vert {y}_{coil} \vert = ( {y}_{max} - {y}_{min} ) \times {( \frac{winding number}{total number of windings} )}^{a} + {y}_{min}$$

where x_{coil} and y_{coil} are coordinate values for a given stretch of rectangular windings as defined by the wind number, which is the quantized parameter going from zero to a maximum value of total number of windings. The maximum and minimum values for the coil winding (xₘₐₓ,yₘₐₓ and xₘᵢₙ,yₘᵢₙₓ respectively) are set for the desired application. Spacing parameter a can have any value. a=1 yields a uniformly spaced coil; a>1 results in coils where spacing is widened towards the perimeter; and a<1 results in coils where spacing is widened towards the center. A value of about a=0.5 was found to minimize variation in the magnetic field intensity. The outermost windings of the coil may have the smallest possible gap, which is set by the dimensions of the coil wires and any necessary coil-support structure.

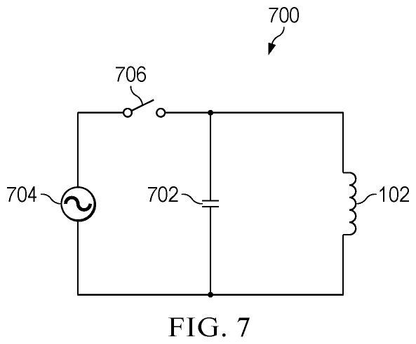

Referring now to FIG. 7, a simplified schematic of an example control circuit 700 method for the induction coil 102 in FIGS. 1 and 2 is shown. The circuit 700 may be a single tank configuration having a single resonant frequency based on the coil 102 and associated capacitor 702. A power supply 704 controls current levels in the induction coil 102 to power the coil from 0 to 1800 watts. In another embodiment, where such power is available, the coil 102 may be capable of managing higher power levels (such as 2200 watts or more). An appropriate switch 706 or relay (possibly electronically controlled) may be provided as needed and as known in the art.

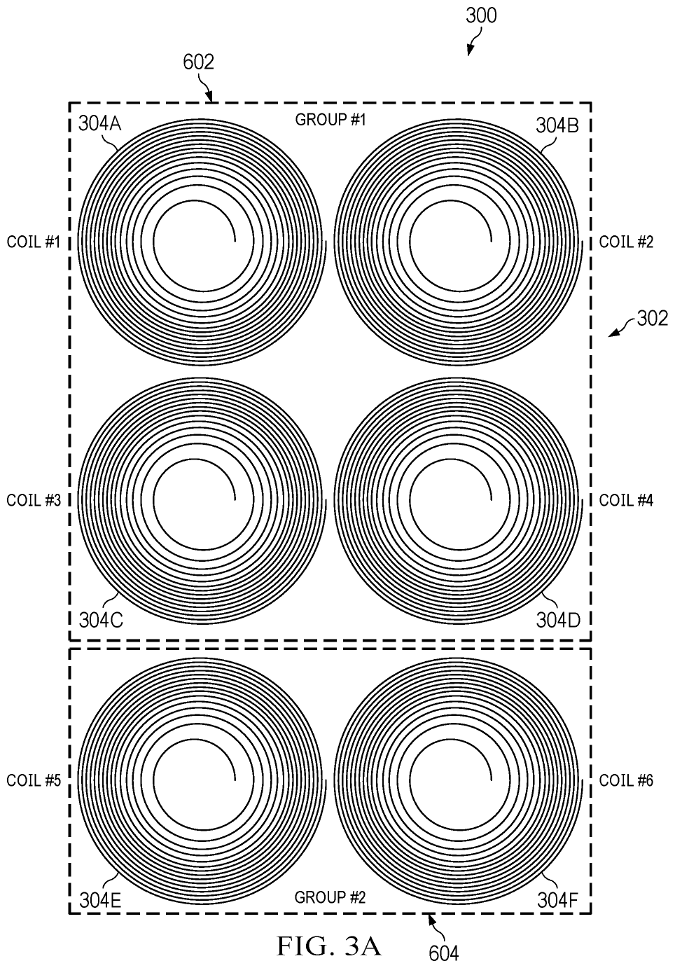

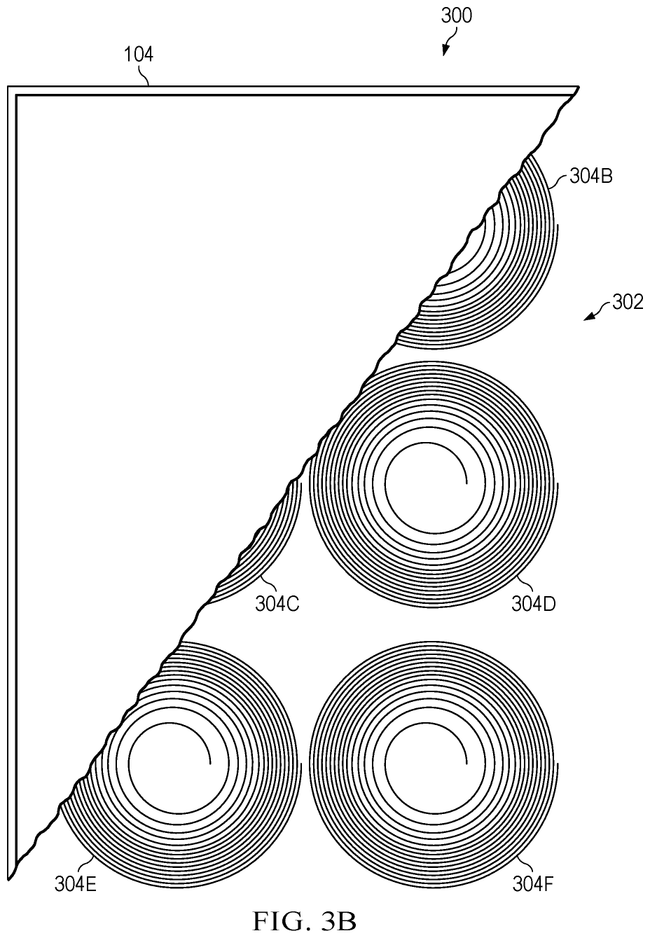

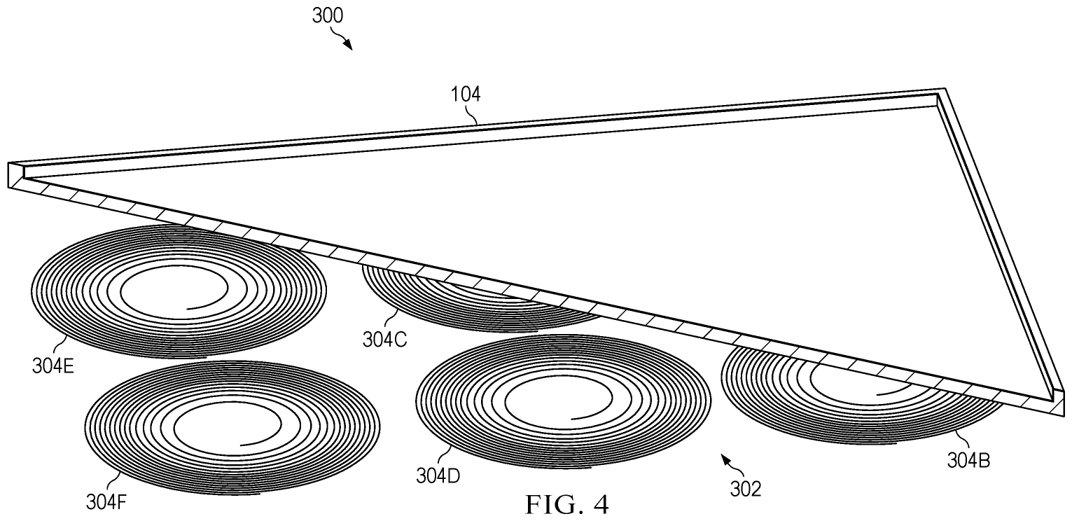

In other embodiments, coil arrangements may be more oblong or oval shape than square or rectangular. Referring now to FIG. 3A an overhead view of an induction coil arrangement 302 as part of a cooking system 300 according to the present disclosure is shown. FIG. 3B illustrates an overhead view of the system 300 with a rectangular cooking surface 104 shown in partial cutaway. FIG. 4 illustrates the system 100 in perspective view.

FIG. 3A illustrates an embodiment of a system 300 that utilizes an arrangement 302 of a plurality of coils 304A, 304B, 304C, 304D, 304E, 304F, each of which may be identical or substantially similar to the other. In other embodiments, the arrangement 302 may have more or fewer coils. The coils 304A, 304B, 304C, 304D, 304E, 304F are also labelled as Coil #1 through Coil #6, respectively. The coils may be arranged into groups of coils as discussed further below. Here, coils 304A, 304B, 304C, 304D are grouped into Group #1 602 next to coils 304E, 304F in Group #2 604.

FIGS. 3-6 illustrate the arrangement 302 of six non-uniformly, circularly wound coils 304A, 304B, 304C, 304D, 304E, 304F, each of the same design. The arrangement 302 may be configured to heat rectangular surfaces, such as the cooking surface 104.

The inner-most windings for each coil 304A, 304B, 304C, 304D, 304E, 304F may be more widely spaced than the edge windings or outer windings to generate the most uniform magnetic field possible. The spacing of the windings may be based on the following parameterized relation:

$${r}_{coil} = ( {r}_{max} - {r}_{min} ) \times {( \frac{winding number}{total number of windings} )}^{a} + {r}_{min}$$

where r_{coil} is the radius of a coil at a given point as defined by the wind number, which is the continuous parameter going from zero to a maximum value of total number of windings. The maximum and minimum values for the coil winding (rmax and rₘᵢₙ respectively) are set for the desired application. The spacing parameter a can have any value (a=1 yields a uniformly spaced coil) but a value of a=0.5 can minimize variation in the magnetic field intensity. The outermost windings of the coil have smallest possible gap, which is set by the dimensions of the coil wires and the coil support structure.

To maximize the magnetic field strength inside the coil windings (not between the different coils) while all coils are being energized, the phase of the alternating current in each coil may be different than each closest neighboring coil. For example, using FIG. 3A as a reference, Coils shown as 1, 3, and 5 have may have alternating currents in phase with each other while Coils shown as 2, 4, and 6, may have alternating currents that are exactly out of phase with the currents of Coils 1, 3, and 5. This may be based on the properties of the coil/tank circuits.

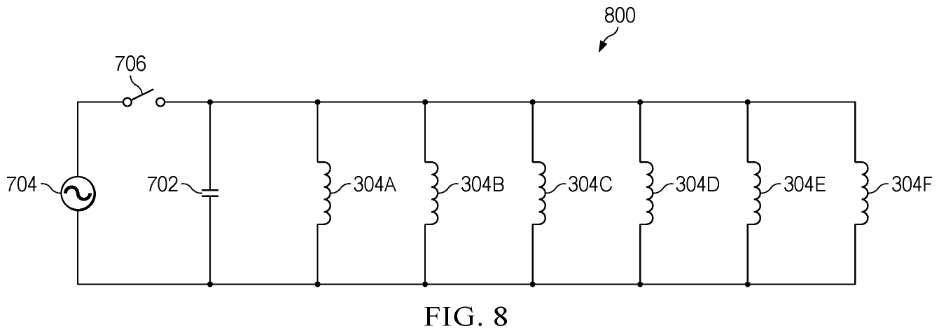

Referring now to FIG. 8, a simplified schematic of an example control circuit 800 for the system 300 allows all six coils to utilize a common tank circuit and switch gear. Here, the coils (304A, 304B, 304C, 304D, 304E, 304F) are wired in parallel.

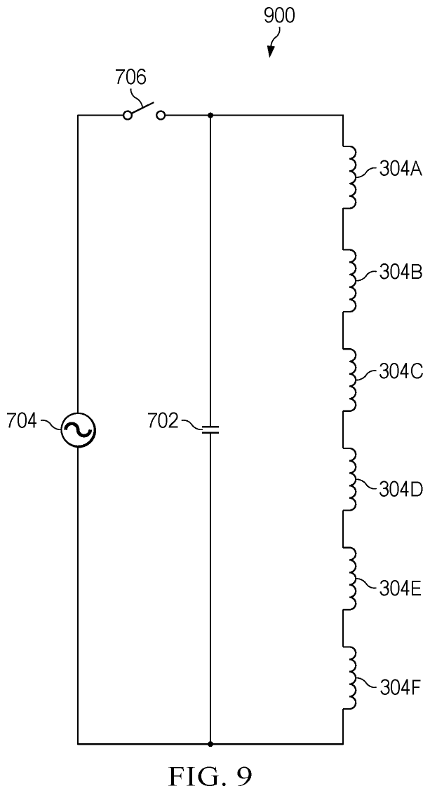

Referring now to FIG. 9, a so implied schematic of another example control circuit 900 for the system 300 allows all six coils to utilize a common tank circuit and switch gear. Here, the coils (304A, 304B, 304C, 304D, 304E, 304F) are wired in series with one another.

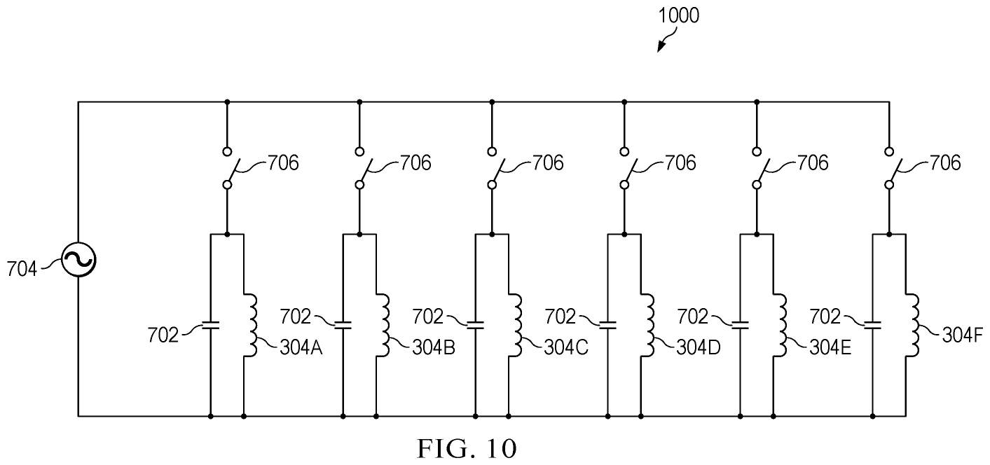

Referring now to FIG. 10, third example control circuit 1000 for the system 300 allows each coil (304A, 304B, 304C, 304D, 304E, 304F) to have its own tank circuit and switch gear 706. This allows independent control of each coil, while maintaining a total maximum power available (from an outlet, for example, power supply 704), for precise zonal heating. In various embodiments, up to maximum power available to the system 300 can be apportioned to any one of the coils 304A, 304B, 304C, 304D, 304E, 304F or a subset thereof (e.g., Group #1, or Group #2, a shown in FIG. 3A).

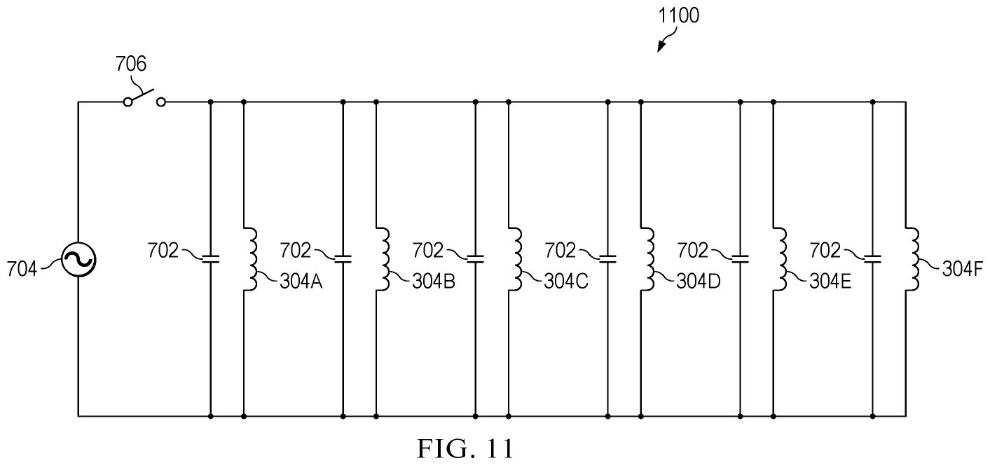

Referring now to FIG. 11, a fourth example control circuit 1100 for the system 300 allows each coil (304A, 304B, 304C, 304D, 304E, 304F) to possess its own tank circuit, but use a shared switch gear 706. If one or more of the coil tank circuits has a resonant frequency sufficiently different than the rest, then the frequency of the switching of the switch gear can be systematically controlled to divert power between the coil or coils with differing resonant frequencies. It should be understood that the switch gear 706 may represent a solid state circuit or switch, possibly being operated with a microcontroller, and with sufficiently fast switching capabilities to apportion power appropriately.

A fifth example control circuit and method for the system 300 uses any of the above-described example control methods or circuit in application within particular coil groups or sub-zones inside the same cooking zone. FIG. 3A gives an example of coil groupings or sub-zones (Coils #1-4 in Group #1, Coils #5-6 in Group #2). Coils need not be adjacent to be in the same grouping, although non-contiguous grouping of coils may limit the practical selection of control methodology. Different groups may use different control methods depending on the particular application.

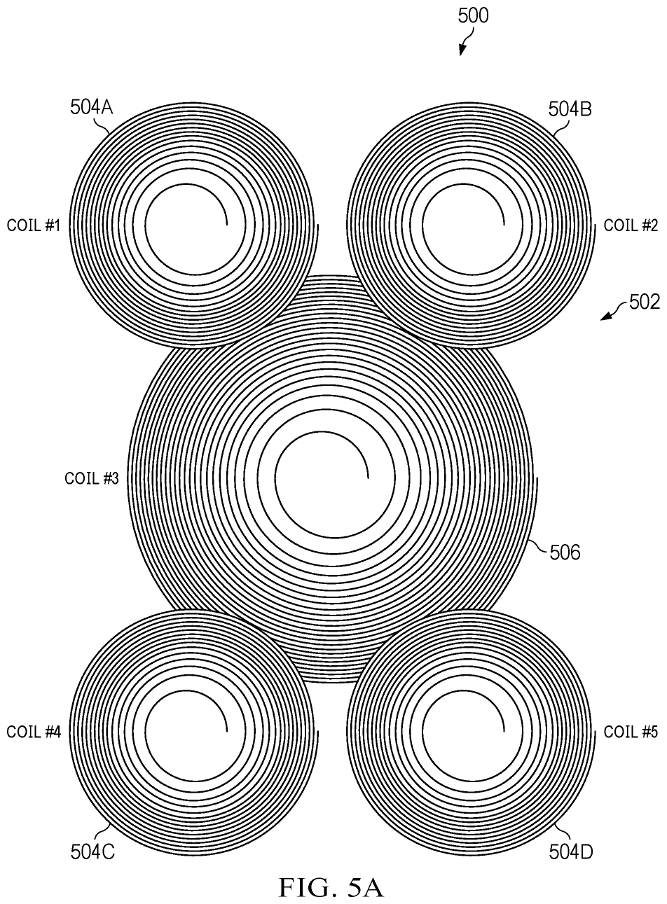

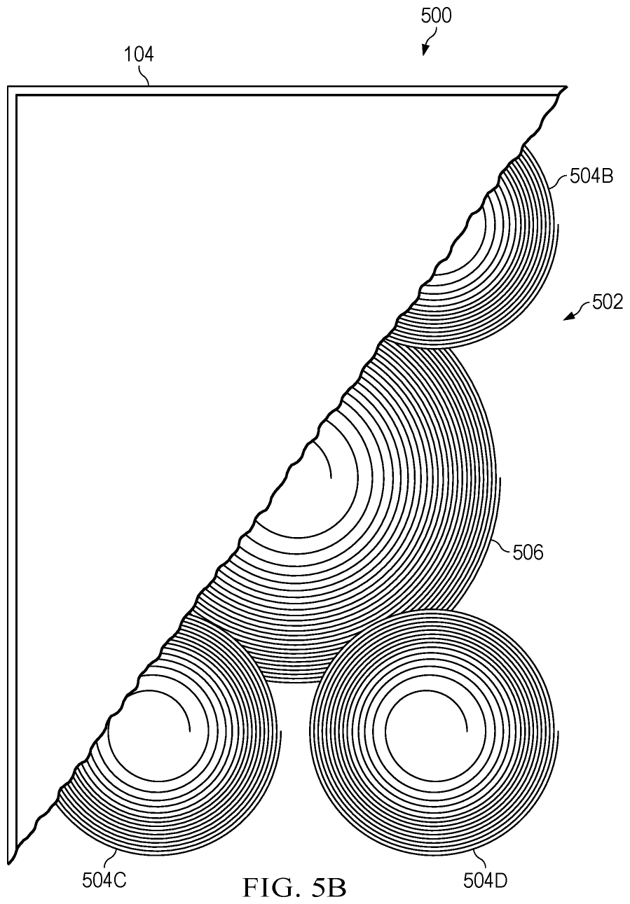

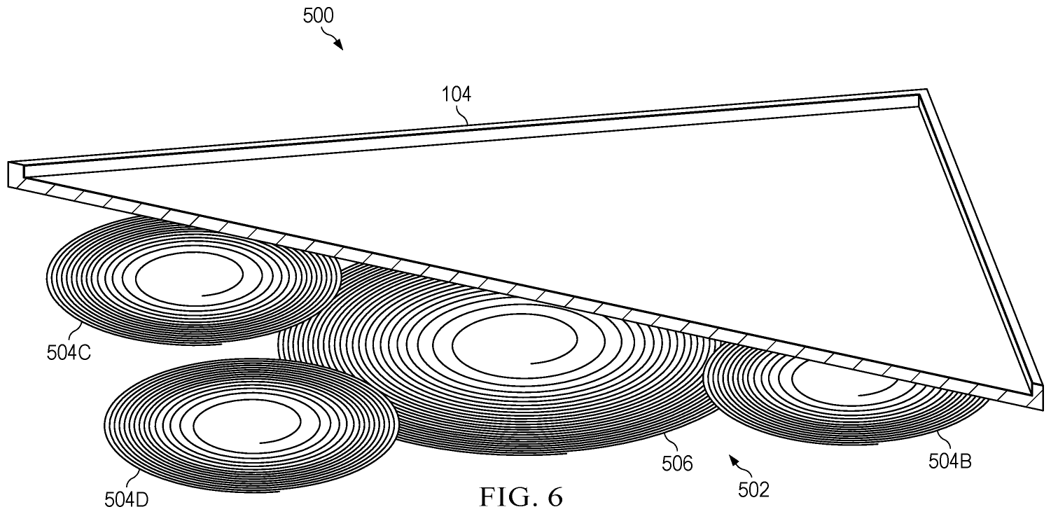

Referring now to FIG. 5A an overhead view of an induction coil arrangement 502 as part of a cooking system 500 according to the present disclosure is shown. FIG. 5B illustrates an overhead view of the system 500 with a rectangular cooking surface 104 shown in partial cutaway. FIG. 6 illustrates the system 500 in perspective view.

The coil arrangement 502 may include five non-uniformly, circularly wound coils. Four of these coils, 504A, 504B, 504C, and 504D (also labelled Coil #1, Coil #2, Coil #4, and Coil #5, respectively) may have the same of a substantially similar design. Another coil 506 (Coil #3) may be arranged in the center of the other four (which may be arranged in a square or rectangle). Coil 506 may have a larger outer radius than the other coils 504A, 504B, 504C, and 504D. In another embodiment, the central coil 506 has a smaller overall diameter. In further embodiments, any of the coils in the arrangement 502 may have different overall geometry (e.g., as described above). As shown, the center coil 506 is positioned vertically below the other coils to prevent physical interference. The inner-most windings for each coil are more spaced than the edge windings to generate the most uniform magnetic field possible. The spacing of the windings may be based on the following parameterized relation:

$${r}_{coil} = ( {r}_{max} - {r}_{min} ) \times {( \frac{winding number}{total number of windings} )}^{a} + {r}_{min}$$

where r_{coil} is the radius of a coil at a given point as defined by the wind number, which is the continuous parameter going from zero to a maximum value of total number of windings. The maximum and minimum values for the coil winding (rₘₐₓ and rₘᵢₙ respectively) are set for the desired application. The spacing parameter a can have any value (a=1 yields a uniformly spaced coil) but has a value of a=0.5 for this invention to minimize variation in the magnetic field intensity. The outermost windings of the coil may have smallest possible gap which is set by the dimensions of the coil wires and the coil support structure.

To maximize the magnetic field strength inside the coil windings (not between the different coils) while all coils are being energized, the phase of the alternating current in each coil can be changed. For example, using FIG. 5A as a reference, Coils 1, 2, 4, and 5 have alternating currents in phase with each other while Coil 3 has an alternating current that is exactly out of phase with the currents of Coils 1, 2, 4, and 5. This may be based on the properties of the coils/tank circuits.

A first example control circuit and method for the coil arrangement 502 allows all five coils to share a common tank circuit and switch gear. The coils 504A, 504B, 504C, and 504D are wired in series to each other (e.g., similar to the configuration of FIG. 9).

A second example control circuit and method for the coil arrangement 502 allows each coil to utilize its own tank circuit and switch gear, thereby allowing independent control of each coil for precise zonal heating (e.g., similar to the configuration of FIG. 10). In various embodiments, up to maximum power available to the system 500 may be apportioned to any one of the coils 504A, 504B, 504C, 504D, 506 or a subset thereof.

A third example control method for the coil arrangement 502 allows each coil to possess its own tank circuit with shared switch gear (e.g., similar to FIG. 11), or have selected coils share a tank circuit. If one or more of the coil tank circuits has a resonant frequency sufficiently different than the rest, then the frequency of the switching of the switch gear can be systematically controlled to divert power between the coil or coils with differing resonant frequencies. For example, if tank circuit(s) for Coils 1, 2, 4, and 5 (504A, 504B, 504C, 504D), have the same resonant frequency that differed from that of Coil 3 (506), the result would be a control method for heating either the perimeters of the cooking surface using Coils 1, 2, 4, and 5 or the center of the cooking surface using Coil 3.

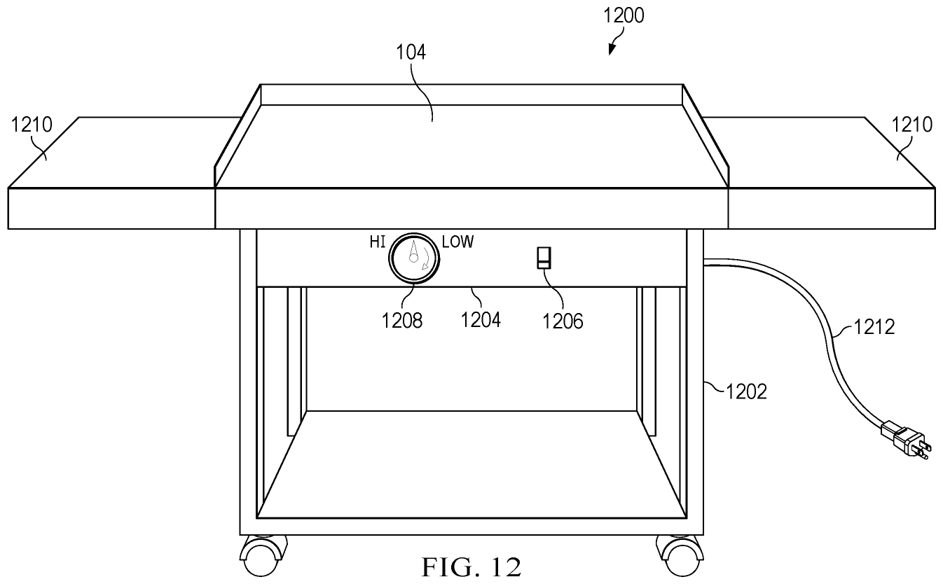

Referring now to FIG. 12, a front perspective view of one embodiment of a griddle 1200 according to aspects of the present disclosure is shown. The griddle 1200 is for illustrative purposes as an example of a griddle embodying any of the inductions systems described herein. The griddle 1200 may comprise a cart 1202, which may or may not be wheeled. The cooking surface 104 can be seen on top of a firebox or cabinet 1204. Coils and internal control circuitry may be situated below the cooking surface (e.g., inside the cabinet 1204 or in a another suitable location). User controls such as a power switch 1206 and/or a temperature control knob 1208 may be provided in a convenient location such as the cabinet 1204. These may provide necessary inputs to control circuity or microcontrollers operating the induction coils, switches, and associate circuits as known in the art. It should be understood that the user controls may differ from that shown (e.g., where the cooking surface 104 is divided into separately operable zones, for example). Power to the griddle 1200 may be supplied from a household AC circuit via power cord 1212.

Side shelves 1210 and other convenience features may be provided as known in the art. It should be understood that hoods, lids, covers, etc. may be provided. In some embodiments the griddle may be permanently installed and may not utilize a cart 1212.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A coil system for inductive heating of a cooking surface comprising:
at least one coil having a continuous winding from a center region to an outer region;
wherein a spacing within adjacent wires in the winding varies between a center of the winding and an outer portion of the winding.

2. The coil system of claim 1, wherein the spacing is larger at center region than the outer portion.

3. The coil system of 2, wherein the at least one coil is rectangular.

4. The coil system of 2, wherein the at least one coil is circular.

5. The coil system of claim 1, wherein the at least one coil comprises a plurality of coils.

6. The coil system of claim 5, wherein the plurality of coils are each about the same size.

7. The coil system of claim 5, wherein the at least two of the plurality of coils differ in size.

8. The system of claim 5, wherein the plurality of coils comprises a first inner coil and a group of outer coils.

9. The system of claim 8, wherein the first inner coil is larger than any coil in the group of outer coils.

10. The system of claim 5, wherein each coil in the plurality of coils has a separate tank circuit.

11. The system of claim 10, wherein each coil in the plurality of coils is switched by a plurality of separate switches to a power supply.

12. The system of claim 10, wherein each coil in the plurality of coils is switched by a single switch to a power supply.

13. The system of claim 3, wherein the at least one coil further comprises stretches of rectangular winding having spacings therebetween governed by the equation:
$$\vert {x}_{coil} \vert = ( {x}_{max} - {x}_{min} ) \times {( \frac{winding number}{total number of windings} )}^{a} + {x}_{min}$$
$$\vert {y}_{coil} \vert = ( {y}_{max} - {y}_{min} ) \times {( \frac{winding number}{total number of windings} )}^{a} + {y}_{min}$$
where x_{coil} and y_{coil} are coordinate values for a given stretch of rectangular windings as defined by the wind number, which is the quantized parameter going from zero to a maximum value of total number of windings and the maximum and minimum values for the coil winding (xₘₐₓ,yₘₐₓ and xₘᵢₙ,yₘᵢₙ respectively) are predetermined.

14. The system of claim 4, wherein the at least one coil comprises a plurality of winding lengths having spacings therebetween governed by the equation:
$${r}_{coil} = ( {r}_{max} - {r}_{min} ) \times {( \frac{winding number}{total number of windings} )}^{a} + {r}_{min}$$
where r_{coil} is the radius of the coil at a given point as defined by the wind number, which is the continuous parameter going from zero to a maximum value of total number of winding lengths from a center of the coil, and the maximum and minimum values for the coil winding (rₘₐₓ and rₘᵢₙ respectively) are predetermined.

15. An inductive cooking device comprising:
a cooking surface; and
at least one induction coil below the cooking surface;
wherein the at least one induction coil comprises a winding comprising adjacent lengths of winding;
wherein the adjacent lengths of winding have a spacing that varies between a center of the coil and an edge of the coil.

16. The inductive cooking device of claim 14, wherein a spacing between adjacent lengths increases from the edge to the center of the coil.

17. The inductive cooking device of claim 15, wherein the at least one induction coil has a non-circular arrangement to induce heat in a non-circular area on the cooking surface.

18. The inductive cooking device of claim 15, wherein the at least one induction coil comprises a plurality of adjacent circular coils arranged below the cooking surface to induce heat in non-circular area on the cooking surface.

19. An inductive cooking device comprising:
a power supply;
a power switch;
a rectilinear cooking surface; and
an induction coil below the cooking surface arranged in a tank circuit to be energized by the power supply via the power switch;
wherein the induction coil comprises a plurality of winding lengths having a spacing between adjacent ones of the plurality of winding lengths that decreases from a center of the coil toward a perimeter of the coil.

20. The inductive cooking device of claim 18, wherein the induction coil is rectangular.

21. The inductive cooking device of claim 18, wherein the induction coil comprises a plurality of circular coils each with a plurality of winding lengths having a spacing between adjacent ones of the plurality of winding lengths that decreases from a center of the coil toward a perimeter of the coil.
